(19) United States
(12) Patent Application Publication
(10) Pub. No.: US 2010/0187776 A1
(43) Pub. Date: Jul. 29, 2010

(54) METHOD OF ACTUATING A CHUCK AND GRIPPING SYSTEM FOR CARRYING OUT THE METHOD

(76) Inventors: Rolf Speer, Lorch (DE); Thomas Vetter, Lorch (DE)

Correspondence Address: KF ROSS PC, 5683 RIVERDALE AVENUE, SUITE 203 BOX 900, BRONX, NY, 10471-0900, US

(21) Appl. No.: 12/667,516

(22) PCT Filed: Jun. 19, 2008
(86) PCT No.: PCT/EP08/04917

§ 371 Date: Jan. 7, 2010

(30) Foreign Application Priority Data
Jul. 12, 2007 (DE) 10 2007 032 416.4
Oct. 11, 2007 (EP) 07 019 880.9

(51) Int. Cl. B23Q 17/00; B23B 31/28

(52) U.S. Cl. 279/126; 29/407.05

(57) ABSTRACT

The invention relates to a method which is used to actuate a tensioning apparatus (3) for tensioning a tool or workpiece. The tensioning apparatus comprises an electric drive (2), in which devices for measuring motor currents and motor positions are integrated in order to monitor tensioning processes carried out using the tensioning apparatus (3).

The invention relates to a method of actuating a chuck, as well as a gripping system for carrying out the method.

Gripping systems with chucks are used in various designs in order to grip tools, such as, for example, drills or millers. Chucks that are used to grip a tool in a tool holder typically consist of jaws or a set of gripping elements that are distributed angularly in the tool holder. Further, chucks of the type that are being addressed here are used for gripping workpieces.

Chucks are typically opened or closed by mechanical adjustment elements. For example, chucks in the form of jaws are usually mounted in an axially displaceable holder and can then be actuated by an axially displaceable tapered tie rod, i.e. they can be moved. The required gripping forces for gripping the tool are thereby applied by springs that push the tapered tie rod against the jaws. Release of the tool from the chuck then takes place hydraulically, as the tongs are pushed back against the spring forces of the spring sets by a hydraulic actuator.

In DE 101 01 096, a method of actuating a chuck for tools is described that is provided at a spindle that can be driven rotationally and has an actuator for the rod. In this method, the axial gripping force exerted by the actuation rod upon a tool tensioned against the spindle is controlled, preferably also during operation and the rotation of the spindle, the dimension of the gripping force being adjusted and controlled relative to the tool.

The actuation rod is driven by an electrical motor. The actual values for the adjustment are determined by a sensor that is mounted between the spindle and the tool and that measures the forces there.

The object of the invention is to provide a method of actuating a chuck as well as a gripping system such that for a small design effort a high functionality is given during use of the chucks.

To attain this object, the characteristics of claims 1 to 15 are provided. Advantageous embodiments and advantageous further developments of the invention are described in the subordinate claims.

The method in accordance with the invention is for actuating a chuck for gripping a tool or workpiece. The tool comprises an electrical drive in which units are integrated for measuring motor currents and motor positions and for controlling the gripping operations performed by the chuck. Furthermore, a gripping system for carrying out the method is provided.

For complex workpieces, especially also multiple gripping systems, this means several gripping systems according to the present invention, can be used. The gripping system in accordance with the invention can thereby by used in general for gripping fixed workpieces or moving, in particular rotating, workpieces. The chuck for gripping workpieces can, in general, be provided with symmetrically rotating gripping tools, whose diameters can be varied by tapered steps. Further, two-jaw assemblies or the like can also be used as gripping tools.

An essential advantage of the method in accordance with the invention or the gripping system according to the invention, consists in that the necessary gripping forces for gripping of the tool or the workpiece can be supplied solely by the electrical drive, so that the mechanical system such as the spring assemblies for closing of the chuck, as well as the hydraulic units for opening the chucks, can be eliminated.

In order to ensure the required operational safety of the chuck, it is helpful in electrical gripping systems of this type to determine the gripping forces when carrying out the gripping operations. In the gripping system in accordance with the invention, this is done in a structurally easy way thereby, in particular by sensors integrated within the electrical drive, and thus the motor currents, as well as the motor positions can be determined.

The measured motor currents supply measurements of the gripping forces that are present. As a result of the additional measurements of the motor positions, a space-resolved measurement of gripping force is made possible, and this is accomplished without using expensive external sensors, as the sensors are integrated into the drive itself.

Using these measurement variables, a precise and comprehensive control of the gripping operations that are performed with the chuck is possible.

In general, the measurements can be performed during the gripping operation itself, so that there is no additional time requirement for the measurements. Alternately, the measurements can be performed in a measuring operation that is separate from the gripping operation. This way, the chuck is moved more slowly during the measuring operation than during the gripping operation, in order to thereby increase the precision of measurement. Particularly advantageously, the operator of the gripping system has the ability to select whether he wants to integrate the measuring operation into the gripping operation or not.

According to a first aspect of the invention, the measured motor currents and motor positions are used for controlling the electrical drive, in order to thus actively control the gripping operations that are to be performed. It is important for this control that the measured motor currents are a gauge for the actual gripping forces, the knowledge of which is critical for carrying out controlled closing and opening motions of the chuck. The calculation of the gripping force takes place using the measured motor currents of a physical model in which the relevant physical actuating variables such as friction, elasticities and kinematic relationships are used. The additional measurement of the motor position further results in a gauge for the actual position of the chuck, so that for the control of the electrical drive, space-resolved information is available concerning the actual gripping forces.

In a particularly advantageous embodiment of the invention, the control of the electrical drive is performed in such a way that on approach of the chuck to the tool, and correspondingly, on moving away from the tool, the position of the drive is monitored. Advantageously but not compulsorily, at a certain point of the gripping operation, a switching to a force control or moment control is performed, i.e. an adjustment of the electrical drive depending on the measured motor currents. Thus, a floating switchover between position control and force control takes place. This control is adapted to the chronological progression of the gripping operation and thus leads to an optimization of the gripping operations that are to be performed. This correspondingly applies to the gripping of workpieces.

According to a second aspect of the invention, using the measured motor currents and motor position, parameters are derived by means of which quantitative conclusions concerning the quality of the gripping operations performed are possible. This makes a process control possible in such a way that errors occurring in the gripping operation, particularly material defects can be exposed.

The first parameter of this type is represented by the effective shank diameter of the tool, which can be determined and controlled by the determination of the local distribution, particularly the increase of gripping force depending on the motor position. As the result of the comparison of the measured shank diameter with the set point value, faulty clamping can be detected, for example, i.e. it can be determined if a tool is clamped and if the correct tool has been clamped. Furthermore, one can determine if the tool is outside the specified tolerances. Particularly advantageous, as the result of measuring the local distribution of the increase of the gripping force if the shank has defects or is contaminated can be determined. This also applies to the gripping of workpieces.

Moreover, as a result of measuring dynamic forces and static friction forces as the result of the monitoring of motor current during operations of the chucks, additional parameters can be derived. Measuring dynamic frictional forces supplies a gauge for the quantity of lubricant present within the gripping system or for coatings that are present, the condition of which can be determined thereby. In contrast, measuring static frictional forces supplies a gauge for the self-locking of the mechanical gripping system, i.e. the mechanism of the chuck.

In the following, the invention is described with reference to the drawings. Therein:

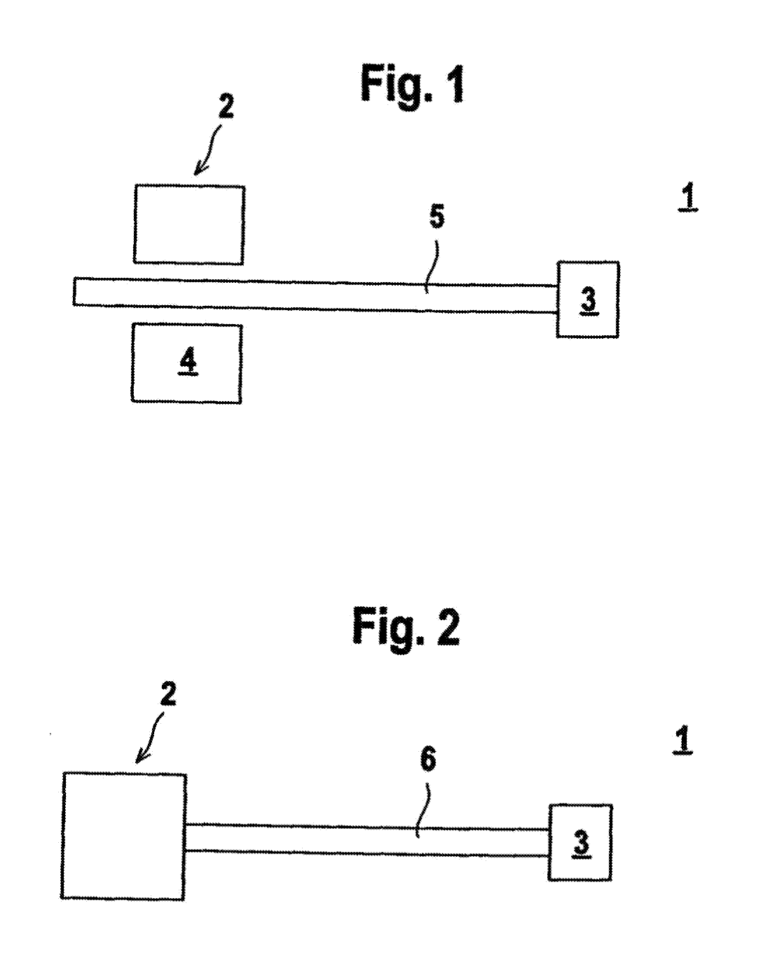

FIG. 1 is a block diagram of a first gripping system with an electrical linear drive.

FIG. 2 is a block diagram of a second gripping system with an electrical drive in the form or a rotary drive with a translation.

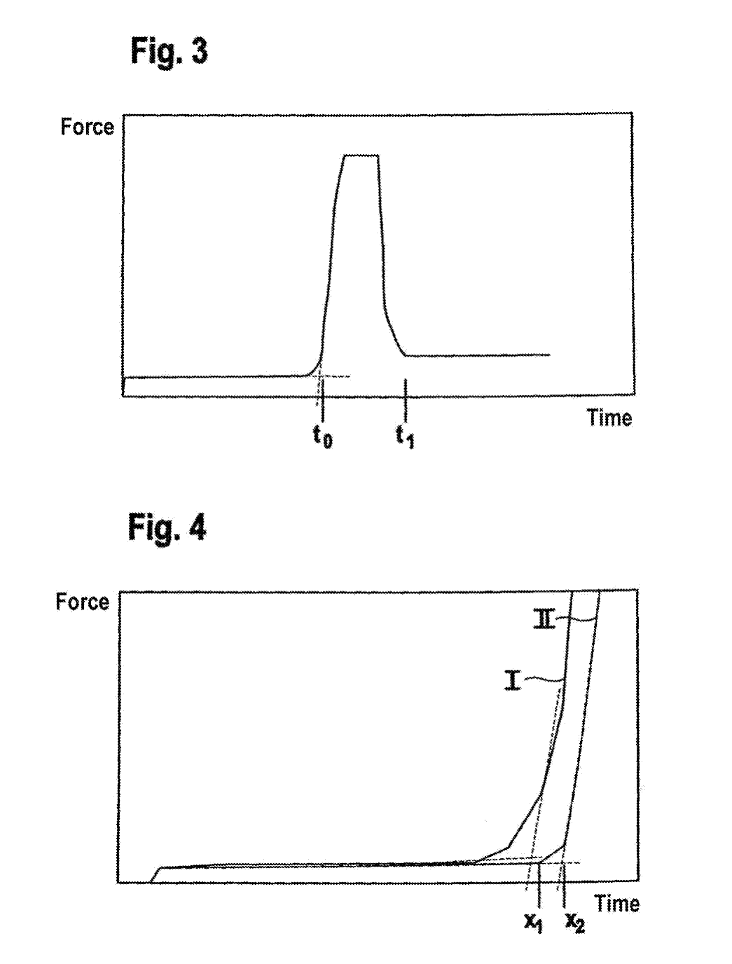

FIG. 3 shows the time-dependent distribution of forces occurring in the execution of a gripping operation by a gripping system as in FIG. 1 or 2.

FIG. 4 shows shank diameter from the position-dependent distribution of the gripping forces for two different tools.

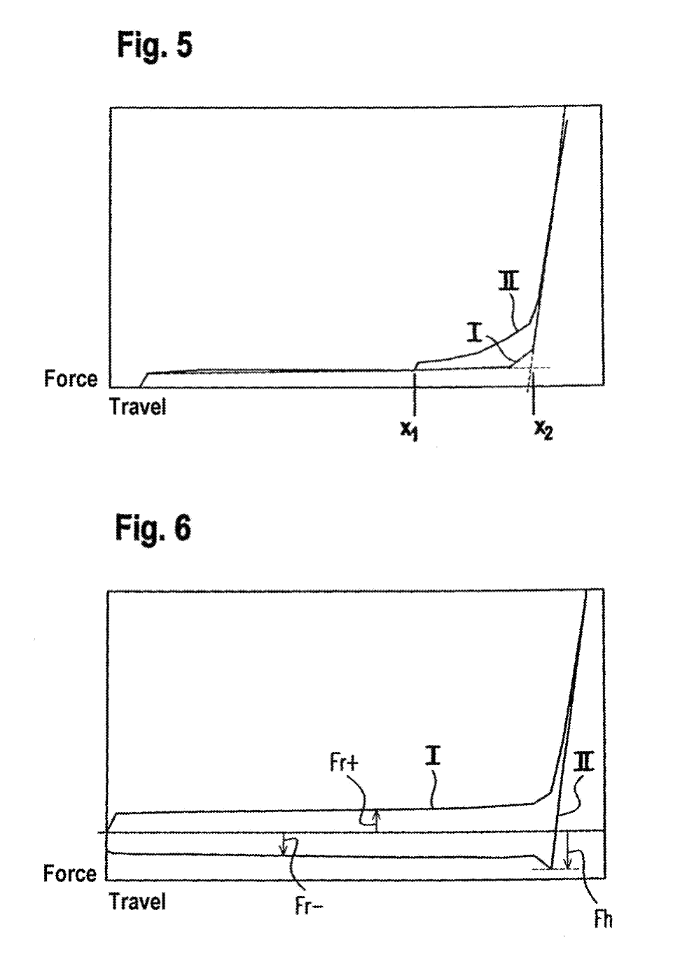

FIG. 5 shows defects or contamination of a shank in the position-dependent distribution of the gripping force.

FIG. 6 shows dynamic and static frictional forces relative to the position-dependent distribution of the grip operation.

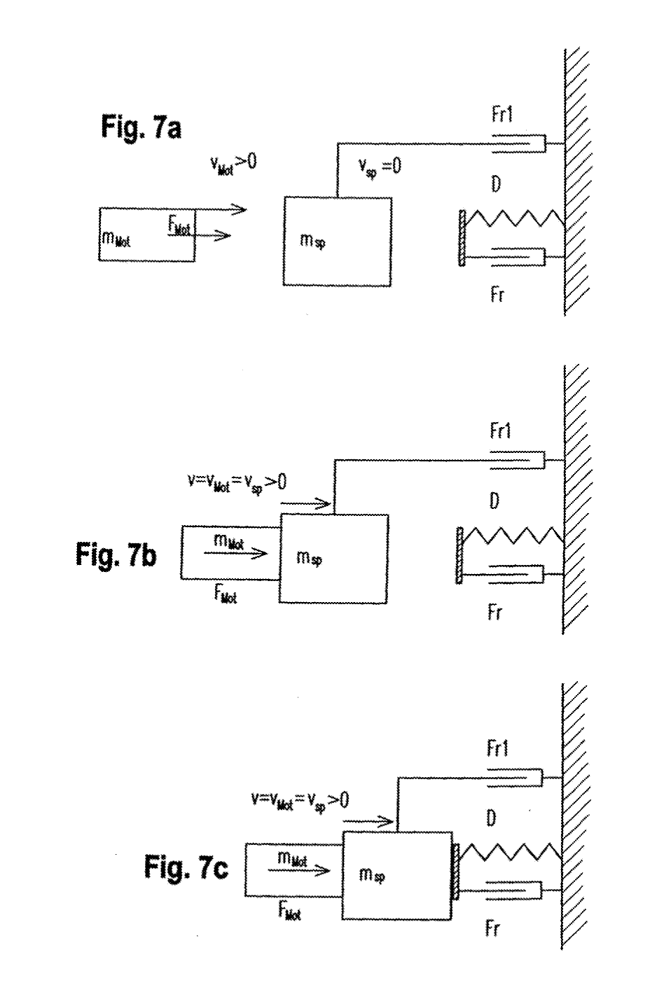

FIG. 7 a-c are models of a gripping system in various phases of the gripping operation.

FIGS. 1 and 2 each schematically show a gripping system 1 for gripping a tool such as, for example, a drill or a miller. Although the figures make reference to a gripping system for tools, the gripping system is generally also suitable for gripping workpieces. In both embodiments, an electrical drive 2 is provided for actuating a chuck 3. The chuck 3 has, as is known, jaws or a clamping assembly with several gripping elements located in a seat of a tool holder.

The electrical drive 2 as in FIG. 1 is a linear drive. As is generally known, it has a stator coil 4 as well as a rod-shaped elongated magnet assembly 5 that is displaced relative to the coils 4. Linear movement of the magnet assembly 5 actuates the chuck 3, i.e. the electrical drive 2 closes and opens the chuck 3. Alternatively, a linear drive can also be used in which the coils 4 are displaced and the magnets 5 are stationary.

The electrical drive 2 as in FIG. 1 is a rotary drive 2 with a transmission in the form of a threaded spindle 6. In this case, the electrical drive 2 acts upon the chuck 3 through the threaded spindle 6.

In the two embodiments within the electrical drive 2, sensors in the form of transmitters or detectors are provided that determine the actual motor positions and motor currents.

These are analyzed with an unillustrated evaluating unit. The motor currents that are measured are analyzed as a gauge of the gripping forces of the gripping operations performed with the chuck 3. The measured motor positions supply a gauge for the actual positions of the chuck 3.

The electrical drive 2 generally consists of an electrical motor and a converter, whereby advantageously the sensors for measuring the motor positions are mounted on the motor and the sensor for measuring the motor current is integrated into the converter. The evaluating unit is provided in the converter or in a controller dedicated to it.

For example, to prevent the tool from falling out of the chuck 3 after an electrical power outage, the mechanical gripping system as in FIG. 2 is designed to be self-locking. This self-locking results from sufficiently large static friction that must be overcome during start-up of the electrical drive 2. This static friction is so large that opening the chuck 3 is not possible without active actuation by the electrical drive 2.

The operation of the gripping system 1 is explained in the following in conjunction with FIGS. 3 to 6 that these apply to both variants of embodiments of gripping system 1 as in FIGS. 1 and 2.

For carrying out gripping operations with the gripping system 1, the electrical drive 2 is controlled, the controller provided to do this being integrated into the converter or into the controller.

The control process is illustrated in FIG. 3 that shows the distribution with respect to time of the forces that occur in the gripping operation.

In time interval 0≦t≦t₀, the startup of the chuck 3 to the tool to be tensioned takes place, i.e. the chuck 3 has not yet made contact with the tool, which means the chuck 3 has not made physical contact with the tool. Even in this time interval, the force that must be exerted by electrical drive 2 is not zero but has a finite value. This force corresponds to the dynamic frictional forces working in the gripping system 1. If the drive 2 is accelerated in this phase, the acceleration force is also added.

In this time interval, position control of the electrical drive 2 takes place depending on the measured values of the sensor for the determination of the actual motor position. As a result of this position control, a certain speed profile of the electrical drive 2 and thus of the motion of the chuck 3 is obtained.

Contact of the chuck 3 with the tool takes place at time t₀, after which in the time interval t₀≦t≦t₁, the tool is gripped by the chuck 3. The force that is determined by measuring the motor currents, i.e. the force for gripping the tool then quickly increases up to a maximum value and then decreases at the end of the gripping operation. In the subsequent time interval t≧t₁, the tool is then maintained with a constant retention force by chuck 3. Usually, during gripping of tools, the motor is decoupled and no longer exerts any force itself. The retention force is then applied by friction. For example, during gripping of fixed workpieces, the motor can remain coupled under force, and thus supply the retention force together with the frictional force.

For times t>t₀, a force control of drive 2 takes place so that with it, the profile of the distribution of force that is shown in FIG. 3 is maintained. For this, the electrical drive 2 is controlled dependent on the motor currents that are determined by the sensor. At time t=t₀, the floating switching between position control and force control takes place.

The actual values for the motor currents and motor positions that are determined by the sensors are not only used for controlling the electrical drive 2, but are also used for the derivation of parameters that, as illustrated in FIGS. 4 and 6, provide information permitting conclusions about the gripping operation, particularly also the quality of the chuck 3. Thereby, FIGS. 4 to 6 show the travel-dependent distribution of forces occurring in the chuck 3, i.e. the gripping forces depending on the actual positions of the chuck 3.

FIG. 4 shows at I and II two travel-dependent distributions of the gripping forces during gripping of two tools with different shank diameters.

Points x1 and x2 define the contact points of the chucks 3 with the tool. As a result of the determination of these points of contact, the effective shank diameters of the individual tools can be established. Even in the present case, in a start-up motion of the chuck 3 toward the tool, a position control of the electric drive 2 is performed and during gripping of the tool, a force control. The shank diameters can then, as shown in FIG. 4, be determined in that the tangents of the partial curves are formed for the position control and the force control, their intersection establishing the effective shank diameter. The shank diameter is derived from the increase of the gripping force and if necessary, additionally from the grip travel.

The shank diameters that have been determined are compared in the evaluating unit with the set points of shank diameters for the individual tools that are stored there. As the result of this comparison it can be determined if the shank diameters are within specified tolerances. Further, it can be determined if the correct tool was tensioned or if it is wedged in the chuck.

FIG. 5 in turn illustrates the travel-dependent distribution of the gripping force during gripping of a tool. Here, the curve labeled I shows the situation when the shank of the tool is error-free. In contrast, the curve labeled II shows that situation when the shank is contaminated.

As the result of contamination, the gripping force increases earlier than in an uncontaminated shank, in return, the increase of the gripping force is smaller, as because of contamination such as turnings, in general, the effective E module of the system consisting of tool and chuck 3 is diminished.

By analysis of the increase of the gripping force it can thus be determined if the shank of the tool is contaminated or not.

FIG. 6 shows a travel-dependent gripping force distribution during gripping of the tool by the chuck 3 (curve I), as well as during opening of the chuck 3 (curve II).

During the start-up motion of the chuck 3 toward the tool and the opening of the chuck 3, i.e. during the times within which position control of the electric drive 2 is performed, a gauge for the dynamic frictional forces F_{R} or −F_{R} in the gripping system 1 is obtained by measuring the motor currents. These in turn provide a gauge for the quantity of lubricant present in the system. These forces also provide information about coatings that are present in the gripping system, such as dry layers.

Directly on the separation of the chuck 3 from the tool, the static frictional force F_{H} required for separating the chuck from the tool is also measured. These static frictional forces F_{H} provide a gauge for the self-locking of the mechanical gripping system.

During separation of the chuck 3 from the tool play is monitored between the rotor as actor of the electric drive 2 that is formed either by the movable part of the linear drive or by the threaded spindle 6 in the rotary friction, as well as that the mechanism of the chuck 3. During separation of the tool, the play can first be overcome with gentle motion, in order to then apply a large force for separating the tool. If this does not lead to a separation of the tool, i.e. the tool is seized in place, the play is then used so that the actor gets a start in order to then separate the chuck promptly with a hammer effect.

The play present between the rotor and the chuck 3 is advantageously also utilized for optimizing the gripping operation, as explained in the following in relating to FIGS. 7a to 7c.

There, in general the play between rotor and chuck 3 is used to accelerate the rotor against the chuck 3, in order to, in addition to the motor force, also transform kinetic energy of the mass of the rotor into gripping forces in order to thus be able to make the forces required for the gripping operation available with certainty. These forces are especially also so large because during the gripping operation self-locking of the drive 2 must be overcome.

In FIGS. 7a to 7c, components of a gripping system 1 like that in FIGS. 1 and 2, are shown and described in the form of a spring mass model. There m_{MOT} and v_{MOT} respectively describe the mass and speed of the rotor, i.e. of the moved mass of the drive of the chuck, and the mass and speed of the chuck of the gripping system 1 forming the chuck 3 are labeled mₛₚ and speed vₛₚ, respectively.

Furthermore, in FIGS. 7a to 7c, the tool is described with reference to the model by a spring constant D and a frictional force F_{R}. Finally, F_{R1} describes an additional frictional force that works against the movement of the mass mₛₚ.

FIG. 7a shows the first phase of the gripping operation in which, because of the play that is present between the rotor and the clamping elements, the rotor can be accelerated toward the clamping elements. Accordingly, the motor force F_{Mot} exerted by the drive 2 acts upon the mass m_{Mot}, as a result of which it is accelerated. In contrast, the mass mₛₚ of the clamping elements is still in a rest position (vₛₚ=0).

The larger the play, the more momentum can be gained by the rotor in this phase and the larger is the speed of the rotor V_{Mot} shortly before actually engaging the mass Mₛₚ.

FIG. 7b shows the second phase of the gripping operation after the rotor engages the clamping elements. After collision of the masses mₛₚ and m_{Mot}, they move together further at a speed of v, i.e. a good approximation of an inelastic impact is present.

The speed v of the entire system of the rotor and the chuck directly after the convergence is

v=m_{Mot}*V_{Mot}/(m_{Mot}+mₛₚ)

Subsequently, both masses, i.e. m=m_{Mot}+mₛₚ, are accelerated further for a certain distance subject to the influence of a first frictional force F_{R1}, and thereby take on even more kinetic energy.

FIG. 7c shows the third phase of the gripping operation at the beginning of the actual gripping of the tool with the chuck.

At the beginning of this gripping operation, the motor and chuck have the speed vₛ and impinge on the tool, which can be described by an effective spring constant D and a frictional force F_{R} according to Hooke's Law. The frictional force F_{R}—in a first approximation, is independent of the speed, however proportional to the gripping force (i.e. also to the grip travel) itself. The additional mass of the tool itself that is moved during gripping is negligible because of the high transmission ratio. During gripping, the motor force continues to act, however, the counter forces, namely the spring force and friction F_{R} increase significantly and decrease the acceleration down to 0. At that moment, the drive would start to run back. However, this is prevented by the friction between the chuck 3 and the tool. The frictional force F_{R} then changes its sign and likewise goes positive. It thereby compensates all other attacking forces as long as they do not become larger than the maximum static frictional force. The grip travel (brake travel) becomes larger depending on how high the speed of the impinging masses is shortly prior to the gripping of the tool, and the larger the motor force that is acting during the gripping. The resulting gripping force also becomes correspondingly larger.

As is shown in the model illustrated in FIGS. 7a to 7c, as a result of the utilization of the play between rotor and chuck, as a consequence of the kinetic energy that is utilized in addition to the motor force, the gripping force is significantly increased.

According to the model described in FIGS. 7a to 7c, the grip travel, i.e. the brake travel of the masses m_{Mot} and mₛₚ, can be analyzed as a direct measurement for the gripping force.

Upon engagement of the rotor with the chuck, a high peak force is created that can lead to wear or even to the destruction of bearing parts and the like. To avoid force peaks of this type, a damping element or a spring element such as a spring collar can be provided at the rotor or at the chuck.

### REFERENCE NUMBERS

1 Gripping system
2 Drive
3 Chuck
4 Coil
5 Magnet
6 Threaded spindle

1. A method of actuating a chuck for gripping a tool or workpiece by an electric drive in which units are integrated for measuring motor currents and motor positions and for controlling gripping operations that are performed with the chuck.

2. The method according to claim 1, wherein the measurements are taken during a gripping operation or during a measuring operation in which the chuck is moved at a lower speed than during the gripping operation.

3. The method according to claim 1 wherein from the measured motor current, by using a model which includes relevant physical influencing parameters, the gripping force with which the tool is tensioned by the chuck and/or the separation force for releasing the tensioned tool is determined.

4. The method according to claim 1 wherein a the time-dependent or travel-dependent distribution of the gripping forces is determined.

5. The method according to claim 4, wherein the grip travel of the chuck is analyzed as a gauge for gripping force.

6. The method according to claim 1 wherein the electric drive is operated by a controller.

7. The method according to claim 6, wherein during approach of the chuck to the tool, a position control is performed, and that at a certain point in the gripping operation a switching to a force control or a moment control takes place.

8. The method according to claim 7, wherein a floating switchover takes place between position control and force control or moment control.

9. The method according to claim 1 wherein by measurement of the increase in gripping force, the effective shank diameter of the tool is determined.

10. The method according to claim 9, wherein the measured shank diameter is compared with the set point value.

11. The method according to claim 9 wherein by measurement of the local distribution of the increase of the gripping force, shank defects or contamination are determined.

12. The method according to claim 1 wherein by measurement of motor currents, dynamic frictional forces are determined as parameters for lubricants or coatings present in electrical drive and the chuck.

13. The method according to claim 1 wherein by measurement of motor currents static frictional forces are determined as parameters for self-locking of the chuck.

14. The method according to claim 1 wherein a play between the masses moved by a drive forming a rotor and the chuck is used to increase the gripping force by accelerating the rotor to the chuck.

15. A gripping system for actuating a chuck for gripping a tool or workpiece by an electrical drive, in which units for measuring motor currents and motor positions have been integrated that control gripping operations performed with the chuck.

16. The gripping system according to claim 15, wherein the electrical drive is a linear drive.

17. The gripping system according to claim 16, wherein the electrical drive is a rotary drive with a transmission.

18. The gripping system according to claim 17, wherein the electrical drive has a dedicated threaded spindle as transmission.

19. The gripping system according to claim 15 wherein the electrical drive alone generates forces for gripping the tool with the chuck.

20. The gripping system according to claim 15 wherein support spring sets are provided by means of which—in addition to the gripping forces generated by the electric drive—a prestressing is generated.

21. The gripping system according to claims 15 wherein a damping or spring element is located on the rotor of the drive or of the chuck.
